(19) United States
(12) Patent Application Publication
(10) Pub. No.: US 2006/0286288 A1
(43) Pub. Date: Dec. 21, 2006

(54) METHOD FOR INCREASING THE ADHESION STRENGTH OF A POLYMER

(75) Inventor: Andrew E. Fisk, Baltimore, MD (US)

Correspondence Address: KELLY LOWRY & KELLEY, LLP, 6320 CANOGA AVENUE, SUITE 1650, WOODLAND HILLS, CA, 91367, US

(73) Assignee: GREATBATCH, INC., Clarence, NY (US)

(21) Appl. No.: 11/424,282

(22) Filed: Jun. 15, 2006

Related U.S. Application Data
(60) Provisional application No. 60/595,220, filed on Jun. 16, 2005.

(51) Int. Cl. B05D 3/00

(52) U.S. Cl. 427/2.24

(57) ABSTRACT

A process for improving the adhesion of polymers to metal surfaces includes a highly porous layer that is condensed onto a metal substrate to provide a strong bond between the metal substrate and the highly porous layer. A polymer adhesive is deposited on top of the highly porous layer, where the polymer adhesive bonds to the pores that exist in the highly porous layer, improving the adhesion of the polymer adhesive to the metal substrate.

### BACKGROUND OF THE INVENTION

This invention relates to a method for improving the adhesion of a polymer to a metal. More particularly, the present invention relates to a method for condensing a porous layer onto a metal surface and then depositing a polymer layer on top of the porous layer. This method finds particular application in connection with implantable medical devices where adhesive rather than compressive forces are desired to bond a polymer to a metal and maintain biocompatibility.

The increasing use of polymers in the medical device industry has created a need for increased adhesion of polymers to metallic surfaces. Historically, metals have been joined to polymers through the use of adhesive or compressive forces. Polymers and adhesives commonly used in implantable medical devices must remain biocompatible and therefore are restricted in their chemical composition. Polymers and adhesives, which actively react with metallic surfaces, commonly contain acid additives that are harmful to the body. Due to this, the adhesion of polymer and metallic constituents in implantable medical devices is presently limited to compressive forces on the polymer and metallic parts.

Accordingly, there is a need for an improved method to improve the adhesion strength of polymers to a metallic surface in implantable medical devices. The present invention fulfills these needs and provides other related advantages.

### SUMMARY OF THE INVENTION

The present invention relates to a method for adhering a polymer adhesive layer to a metallic substrate. Initially, a layer of highly porous material is condensed onto at least a portion of the metallic substrate. Then, the polymer adhesive layer is deposited on top of the highly porous layer.

The highly porous layer is condensed using a physical vapor deposition process. The physical vapor deposition process can be a bi-modal process including radio frequency enhanced physical vapor deposition or laser assisted physical vapor deposition. An additive may be introduced during the condensing process for the active removal of high energy nuclei sites during condensation.

The highly porous material must comprise a biocompatible material. Preferably, the highly porous material is selected from the group consisting of platinum, titanium, tantalum, palladium and diamond like carbon.

The highly porous layer is condensed such that is comprises a distribution of both mesopores and macropores. The mesopores and macropores preferably have diameters ranging from 1 micron to 20 nanometers. The mesopores and macropores are preferably distributed such that it results in a highly porous layer having an open volume greater than 20% but less than 80% of the total volume of the material.

Other features and advantages of the present invention will become apparent from the following more detailed description, taken in connection with the accompanying drawings which illustrate, by way of example, the principles of the present invention.

### BRIEF DESCRIPTION OF THE DRAWINGS

The accompanying drawings illustrate the invention. In such drawings:

FIG. 1 is a perspective view of a portion of an assembly according to the present invention;

FIG. 2 is an exploded view of the assembly of FIG. 1;

FIG. 3 is depiction of multiple surface structures resulting a physical vapor deposition process;

FIG. 4 is a cross-sectional view of the highly porous layer of FIG. 2, taken along line 4-4; and

FIG. 5 is a cross-section view of the highly porous layer of FIG. 2, taken along line 5-5.

### DETAILED DESCRIPTION OF THE PREFERRED EMBODIMENT

The present invention is direct to a process for improving the adhesive properties of polymer adhesives to metallic substrates in implantable medical devices. Although the inventive process may be used in any area where a polymer adhesive is bonded to a metallic surface, the following description will focus on the inventive process when applied to implantable medical devices.

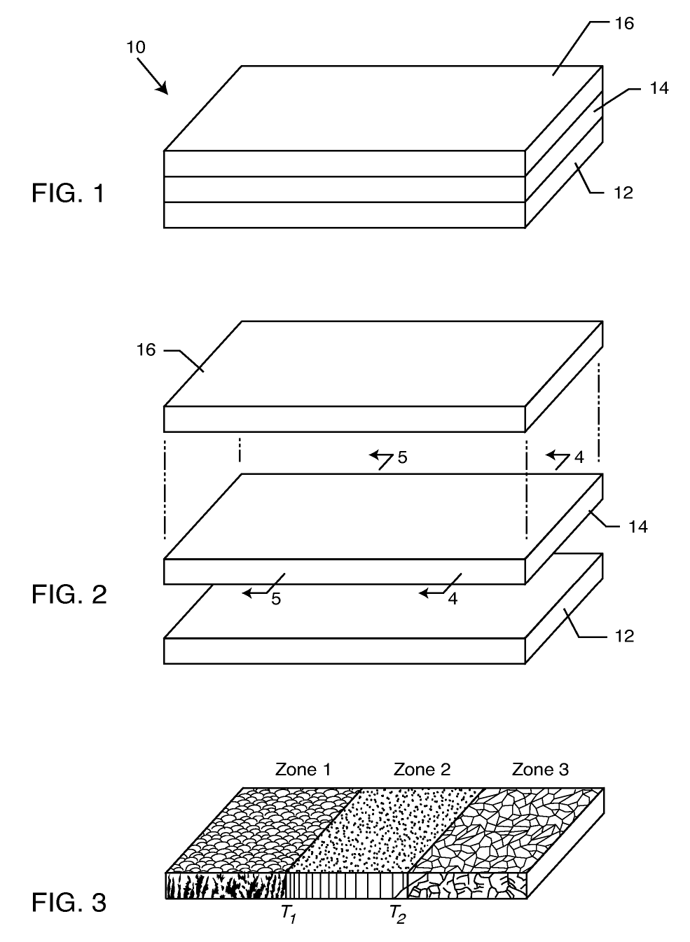

The housing or other exterior surface on an implantable medical device (not shown) is typically constructed from a biocompatible metal. FIGS. 1 and 2 depict a portion 10 of the housing of an implantable medical device having a polymer adhesive adhered to the surface according to the inventive process. In FIGS. 1 and 2, a metallic substrate 12 is shown that corresponds to a portion 10 of the housing of the active implantable medical device. A highly porous layer 14 is shown on the surface of the metallic substrate 12. A polymer adhesive layer 16 is deposited on top of the highly porous layer 14.

The process involves condensing the highly porous layer 14 onto the metallic substrate and then depositing the polymer adhesive layer 16 onto the highly porous layer 14. The act of depositing the highly porous layer 14 on the metallic substrate 12 creates a very strong bond between the highly porous layer 14 and the metallic substrate 12. The openings in the highly porous layer 14 provide areas for the polymer adhesive layer 16 to “grab” onto the highly porous layer 14, thereby providing for a stronger bond. It has been found that the highly porous layer can improve adhesion of the polymer adhesive 16 to the metal substrate 12 by 2-3 times depending upon the processing parameters.

The highly porous layer 14 consists of a material which when condensed onto a metallic substrate 12 provides a layer of high porosity which improves the adhesion of the polymer adhesive layer 16 to the metallic substrate 12. The condensate or highly porous layer 14 is provided such that it has a certain degree of porosity after condensed. The pores 18 of the highly porous layer 14 should be between 1 microns and 20 nanometers in diameter. It is preferred that there to be a distribution of both mesopores and macropores. The pores 18 should be formed such that they are open and accessible to the polymer adhesive layer 16. It is preferred that the pores 18 create an open volume greater than 20% and less than 80% of the total volume of the condensate layer 14.

The condensate layer 14 is preferably made from a biocompatible material, such as those presently used in active implantable medical devices. Such biocompatible materials include, but are not limited to, compounds having platinum (Pt), titanium (Ti), tantalum (Ta), palladium (Pd), diamond like carbon. The material selected for the condensate layer 14 should be based upon the intended application of the implantable medical device. For instance a condensate layer 14 of ZrO₂ can be used to both improve adhesion and provide electrical insulation. In another example, a condensate layer 14 of TiN can be used to provide corrosion resistance, electrical conduction and improved adhesion. In another example, diamond like carbon (DLC) can be used to provide insulative properties, corrosion resistance and improved adhesion.

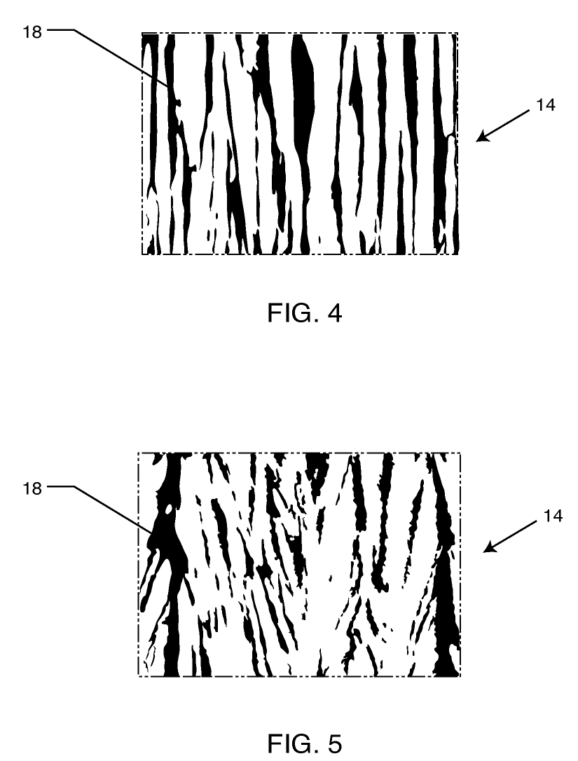

The condensation process by which the highly porous layer 14 is deposited is preferably a physical vapor deposition (PVD) condensation process. Such process can be a PVD condensation process on its own or can employ bi-modal process systems. Such bi-modal process systems include radio frequency enhanced PVD, laser assisted PVD, etc. The processing parameters for the condensate layer 14 should be selected based upon the properties of the material being used. The parameters are chosen such that they correlate to a microstructure as shown in FIGS. 3, 4 or 5.

The primary processing parameters in a PVD process are pressure and temperature. The inventive process relies on a correct selection of T_{d}/Tₘ, where T_{d} is the deposition temperature and Tₘ is the melting temperature. The processing pressure should be optimized in order to provide an acceptable distribution of pores 18 of various sizes and having the desired open volume. The pressure will vary depending on the process used and the rate at which the condensate layer 14 is formed.

In FIG. 3, T₁ and T₂ are defined in terms of the ratio T_{d}/Tₘ, where T_{d} is the deposition temperature and Tₘ is the melting temperature. For metallic condensates T₁ and T₂ have values of 0.3 and 0.45-0.5 respectively. For oxide condensates, Ti and T2 have values of 0.22-0.26 and 0.45-0.5 respectively. The microstructure of a condensed surface is defined by T_{d}/Tₘ, where a Zone 1 structure (FIG. 3 left of T₁) is created at temperature a value of 0-T₁, a Zone 2 structure (FIG. 3 between T₁ and T₂) having a temperature value of T1-T2, and a Zone 3 structure (FIG. 3 right of T₂) having a temperature value of T2-Tm.

A Zone 1 microstructure is characterized by tapered crystallites, which appear as fibrous grains with a poorly resolved inner structure. These grains grow with little definition between neighboring structures and the crystallites continue to increase in diameter as the thickness increases. There is little or no surface diffusion in Zone 1 and mobility of the atoms on the surface is very limited. The initial size of the crystallites and their properties are therefore highly dependent on the surface condition of the substrate. This growth produces a structure with open porosity and high surface area but is very brittle.

As the T_{d} increases, the columns and therefore the domes of the Zone 1 microstructure become larger in diameter. This increase in diameter is due to an increase in surface energy and the introduction of surface diffusion on the forming condensate. At the transition T₁, the width of the columns becomes more defined and uniform.

Zone 2 is characterized by a defined columnar structure in which the width is consistent throughout the thickness. In this region the surface energy is high enough to allow diffusion of some of the condensate prior to solidification. This allows the material to grow in a preferred crystal orientation and crystal growth is the leading contributor to structure. As T_{d} is increased in this region the column widths increase and therefore the porosity and surface area are decreased. A Zone 2 microstructure is less porous but more durable than a Zone 1 microstructure.

At the transition from Zone 1 to Zone 2 a change in the microstructure is noticeable. The columnar structure of Zone 2 produces a homogeneous material, which has an increased abrasion resistance due to a decrease in the loosely adhered dendrite fibers found in Zone 1. It is therefore preferred that the highly porous layer 14 be formed at a temperature in which the transition from Zone 1 to Zone 2 is taking place. The highly porous layer 14 should possess the porosity of the Zone 1 microstructure and the durability of the Zone 2 microstructure.

Zone 3 is created with a high surface energy. A considerable amount of surface diffusion takes place prior to solidification resulting in a dense film with minimal surface area and little porosity.

In standard manufacturing it may be difficult to control the temperature of the substrate 12, either because of material constraints (the substrate may not be able to withstand the necessary temperature) or by processing constraints (the process may produce heat which is absorbed by the substrate causing overheating). An alternative to controlling the substrate temperature is to control the energy of the condensate. The energy of the condensate may be controlled using a coating process.

The coating process consists of coating a substrate with a condensate. The material that makes up the condensate can be in liquid, vapor or solid form. In the most common cases material is found in a solid form commonly called a target or ingot. The material is liberated from the target by a high-energy process and therefore the liberated species contains a certain amount of energy. This energy is a contributor to the surface energy which dictates condensate growth. By reducing the energy of the liberated species, the total surface energy and surface mobility and therefore the surface diffusion can be reduced.

A common processing technique to reduce the energy of liberated species is by collision. As two species come into contact with one another, energy is consumed by the impact. The total number of collisions as dictated by the mean free path of the system can be adjusted by adjusting the processing pressure. In the case of a manufacturing process, it is most often preferred to hold the T_{d} at a temperature that is easily maintained and to adjust the processing pressure to reach the desired microstructure.

The porosity of the condensate layer 14 can be increased by the addition of minor constituents (“additives”) in with the major constituents. The selection of additives is such that they are interactive with the major constituent in complex reactions. These additives are involved in the active removal of high energy nuclei sites. The additives are selected such that they interact with the major constituent of the condensate layer 14 and result in portions of the major constituent being removed from the condensate layer 14 to form the pores 18. The degree of removal of the major constituent by the additive is dictated by the rate of reaction and available reactants.

FIG. 4 depicts the microstructure of a condensate layer 14 that was formed using an additive to a PVD process. In this example of a condensation process using an additive, NaCl (additive) is introduced to the deposition of TiN. TiN is formed in a reactive mode using Ti as a liberated species and N as a reactive gas. During the deposition of Ti and formation of TiN, small amounts of NaCl vapor flux that subsequently disassociate to form Na⁺ and Cl⁻ ions are added. The TiN is deposited to form a condensate layer 14 having a Zone 2 type microstructure.

During the deposition process, chemical interactions on surfaces of the condensate layer 14 form the volatile component TiCl₄ in the form of filaments. This component, upon subsequent energy addition, volatilizes and a resulting pore 18 is formed. In this complex reaction the condensate material is simultaneously deposited and etched to form the highly porous layer 14 having a combination Zone1-Zone 2 microstructure.

FIG. 5 depicts the microstructure of a condensate layer 14 formed using another additive to a PVD process. In this process, zirconium(Zr) is added to the Ti major constituent. In the co-deposition of TiN with ZrO₂, competing phases of TiN (major constituent) and ZrN(minor constituent) are formed. The formation of the minor constituent is limited to areas of high radii condensation. The formation preferentially occurs in this area due in part to the high surface energy and low mobility at the high radii.

This microstructure has an increase in dendritic structure. It is characterized by a material having a relatively low Tₘ deposited with a material with a relatively high Tₘ. The low Tₘ material is therefore depositing in Zone 2 while the high Tₘ material is depositing in Zone 1. The fibrous dendrites created by the Zone 1 deposition create additional sites on which the low Tₘ material can form. The low Tₘ material re-nucleates onto the high Tₘ material due to a relatively fast solidification rate of the low energy high Tₘ material. This formation is designed such that the T_{d}/Tₘ is below that of the major constituent, forming a discontinuous junction.

Although various embodiments have been described in detail for purposes of illustration, various modifications may be made without departing from the scope and spirit of the invention.

What is claimed is:

1. A method for adhering a polymer adhesive layer to a metallic substrate, comprising the steps of:
condensing a layer of highly porous material on at least a portion of the metallic substrate; and
depositing the polymer adhesive layer on top of the highly porous layer.

2. The method of claim 1, wherein the condensing step comprises a physical vapor deposition condensation process.

3. The method of claim 2, wherein the physical vapor deposition condensation process is a bi-modal process including radio frequency enhanced physical vapor deposition or laser assisted physical vapor deposition.

4. The method of claim 1, wherein the highly porous material comprises a biocompatible material.

5. The method of claim 4, wherein the biocompatible material is selected from the group consisting of platinum, titanium, tantalum, palladium, zirconium, and diamond like carbon.

6. The method of claim 1, wherein the highly porous layer comprises a distribution of both mesopores and macropores.

7. The method of claim 6, wherein the mesopores and macropores have diameters ranging from 1 micron to 20 nanometers.

8. The method of claim 6, wherein the distribution of mesopores and macropores results in a highly porous layer having an open volume greater than 20% but less than 80% of the total volume of the material.

9. The method of claim 1, wherein the condensing step further comprises the step of introducing an additive for the active removal of high energy nuclei sites during the condensing process.

10. A method for adhering a polymer adhesive layer to a metallic substrate, comprising the steps of:
condensing a layer of highly porous material on at least a portion of the metallic substrate by a physical vapor deposition process, such that the highly porous layer comprises a distribution of both mesopores and macropores; and
depositing the polymer adhesive layer on top of the highly porous layer.

11. The method of claim 10, wherein the physical vapor deposition condensation process is a bi-modal process including radio frequency enhanced physical vapor deposition or laser assisted physical vapor deposition.

12. The method of claim 10, wherein the highly porous material comprises a biocompatible material.

13. The method of claim 4, wherein the biocompatible material is selected from the group consisting of platinum, titanium, tantalum, palladium, zirconium, and diamond like carbon.

14. The method of claim 10, wherein the mesopores and macropores have diameters ranging from 1 micron to 20 nanometers and the distribution of mesopores and macropores results in a highly porous layer having an open volume greater than 20% but less than 80% of the total volume of the material.

15. The method of claim 10, wherein the condensing step further comprises the step of introducing an additive for the active removal of high energy nuclei sites during the physical vapor deposition process.

16. A method for adhering a polymer adhesive layer to a metallic substrate, comprising the steps of:
condensing a layer of highly porous material on at least a portion of the metallic substrate, such that the highly porous layer comprises a distribution of both mesopores and macropores;
introducing an additive to the highly porous material during the condensing step for the active removal of high energy nuclei sites during the condensing process; and
depositing the polymer adhesive layer on top of the highly porous layer.

17. The method of claim 16, wherein the condensing step comprises a bi-modal physical vapor deposition condensation process including radio frequency enhanced physical vapor deposition or laser assisted physical vapor deposition.

18. The method of claim 16, wherein the highly porous material comprises a biocompatible material selected from the group consisting of platinum, titanium, tantalum, palladium, zirconium, and diamond like carbon.

19. The method of claim 16, wherein the mesopores and macropores have diameters ranging from 1 micron to 20 nanometers.

20. The method of claim 16, wherein the distribution of mesopores and macropores results in a highly porous layer having an open volume greater than 20% but less than 80% of the total volume of the material.
